(19) United States
(12) Patent Application Publication
(10) Pub. No.: US 2024/0322395 A1
(43) Pub. Date: Sep. 26, 2024

(54) BATTERY MODULE INCLUDING BONDING MEMBER AND COATING LAYER

(71) Applicant: SK ON CO., LTD., Seoul (KR)

(72) Inventor: Hyun Seok KIM, Daejeon (KR)

(21) Appl. No.: 18/422,388

(22) Filed: Jan. 25, 2024

(30) Foreign Application Priority Data
Mar. 24, 2023 (KR) 10-2023-0038912

(51) Int. Cl. H01M 50/516; B23K 26/211; B23K 26/322; B23K 101/34; H01M 50/211; H01M 50/503; H01M 50/526; H01M 50/562

(52) U.S. Cl. CPC H01M 50/516; B23K 26/211; B23K 26/322; H01M 50/211; H01M 50/503; H01M 50/526; H01M 50/562; B23K 2101/34

(57) ABSTRACT

Battery modules are disclosed. In an embodiment, a battery module includes a battery cell including an electrode lead; a busbar including a slit accommodating the electrode lead; a first coating layer covering at least a portion of the busbar, and a bonding member disposed between the electrode lead and the busbar and electrically connecting the electrode lead to the busbar.

### CROSS-REFERENCE TO RELATED APPLICATION(S)

This patent document claims the priority and benefits of Korean Patent Application No. 10-2023-0038912 filed on Mar. 24, 2023, the disclosure of which is incorporated herein by reference in its entirety.

### TECHNICAL FIELD

The disclosed technology generally relates to a battery module.

### BACKGROUND

Unlike primary batteries, secondary batteries can be charged and discharged, and thus secondary battery may be applied to devices within various fields such as digital cameras, mobile phones, laptops, hybrid cars, electric cars, and energy storage systems (ESS). Secondary batteries may include lithium ion batteries, nickel-cadmium batteries, nickel-metal hydride batteries, and nickel-hydrogen batteries.

### SUMMARY

The disclosed technology can be implemented in some embodiments to provide a battery module including a bonding member and a coating layer.

A busbar may be used to electrically connect a plurality of battery cells to each other. For example, in a pouch-type battery cell, an electrode lead of a battery cell may be inserted into a slit of a busbar and coupled thereto by welding. However, when the electrode lead or busbar is melted and coupled to a busbar, the welding quality may become poor and/or thermal deformation may occur due to the high temperature (e.g., 660 degrees or 1000 degrees) necessary for melting the electrode lead or the busbar. Also, when the electrode lead and the busbar are directly coupled to each other, the electrode lead and the busbar may be in contact with each other until the electrode lead or the busbar melts, which may cause heat or flames spread and/or a short circuit.

A filler including solder paste may be used to connect the electrode lead to the busbar. However, when a filler is applied to a region between the electrode lead and the busbar, a gap between the electrode lead and the busbar may not be filled, which may increase a defect rate of the battery module. In addition, when a filler is applied to a region between the electrode lead and the busbar, a groove may be needed to dispose the filler in the busbar, which may increase the cost and time required to manufacture the busbar.

In an aspect of the disclosed technology, by connecting a busbar to an electrode lead at a relatively low temperature, a battery module implemented based on some embodiments may have improved welding quality and reduced thermal strain.

In an aspect of the disclosed technology, by separating a busbar and an electrode lead at a relatively low temperature, a battery module implemented based on some embodiments may reduce or prevent the spread of heat and flame and a short circuit between a plurality of battery cells.

In an aspect of the disclosed technology, by connecting an electrode lead to a busbar using a coating layer, a battery module having reduced manufacturing difficulty and a reduced defect rate may be provided.

In some embodiments of the disclosed technology, a battery module may be used in green technology fields such as electric vehicles, battery charging stations, solar power generation, and wind power generation. In addition, the battery module implemented based on some embodiments may be used in an eco-friendly electric vehicle and a hybrid vehicle to prevent climate change by suppressing air pollution and greenhouse gas emission.

In some embodiments of the disclosed technology, a battery module includes a battery cell including an electrode lead; a busbar including a slit accommodating the electrode lead; a first coating layer covering at least a portion of the busbar; and a bonding member disposed between the electrode lead and the busbar and electrically connecting the electrode lead to the busbar.

The bonding member may include a central portion in contact with the electrode lead and the busbar and an edge portion extending from the central portion. A first thickness of the central portion may be greater than a second thickness of the edge portion.

The busbar may include an internal surface forming the slit. A side surface of the electrode lead may be spaced apart from the internal surface of the busbar.

The busbar may include a surface that is not covered by the first coating layer and visually exposed to the outside of the bus bar.

The battery module may further include a second coating layer covering at least a portion of the electrode lead.

A melting point of the bonding member and a melting point of the first coating layer may be lower than a melting point of the electrode lead and a melting point of the busbar.

A width of the slit of the busbar may be within 3 times a width of the electrode lead.

The first coating layer and the bonding member may include at least one of tin (Sn), lead (Pb), copper (Cu), or silver (Ag).

In some embodiments of the disclosed technology, a battery module includes a battery cell including an electrode lead; a busbar including a slit accommodating the electrode lead; and a bonding member disposed in a space inside the slit between the electrode lead and the busbar and electrically connecting the electrode lead to the busbar.

The battery module may further include a first coating layer covering at least a portion of the busbar.

The battery module may further include a second coating layer covering at least a portion of the electrode lead.

The bonding member may include a central portion in contact with the electrode lead and the busbar and an edge portion extending from the central portion. A thickness of the central portion may be greater than a thickness of the edge portion.

The busbar may include an internal surface forming the slit. A side surface of the electrode lead may be spaced apart from the internal surface of the busbar.

In some embodiments of the disclosed technology, a method of manufacturing a battery module includes a process of preparing a busbar covered with a first coating layer; a process of inserting an electrode lead of a battery cell into a slit of the busbar; and a process of coupling the busbar to the electrode lead by melting the first coating layer.

The process of coupling the busbar to the electrode lead may include melting a second coating layer covering the electrode lead together with the first coating layer.

### BRIEF DESCRIPTION OF DRAWINGS

Certain aspects, features, and advantages of the disclosed technology are illustrated by the following detailed description with reference to the accompanying drawings.

FIG. 1 illustrates an example of a battery cell based on an embodiment of disclosed technology.

FIG. 2 illustrates an example of a battery module based on an embodiment of disclosed technology.

FIG. 3 illustrates an example of a battery module based on an embodiment of disclosed technology.

FIG. 4 illustrates an electrode lead and a busbar of an example of a battery cell based on an embodiment of disclosed technology.

FIG. 5 is a cross-sectional diagram taken along line I-I′ in FIG. 4.

FIGS. 6A, 6B, and 6C are cross-sectional diagram illustrating an example of a battery module based on an embodiment of disclosed technology.

FIG. 7 is a flowchart illustrating a method of manufacturing a battery module based on an embodiment of disclosed technology.

### DETAILED DESCRIPTION

Features of the technology disclosed in this patent document are illustrated by example embodiments with reference to the accompanying drawings. However, the disclosed technology is not limited to the specific embodiments described by way of example.

Secondary batteries may be manufactured to include flexible pouch-type battery cells or rigid prismatic or cylindrical can-type battery cells such that a plurality of battery cells are arranged or stacked in a cell assembly.

The cell assembly may be disposed in a module housing and may form a battery module, and a plurality of battery modules may be disposed in a pack housing and may form a battery pack.

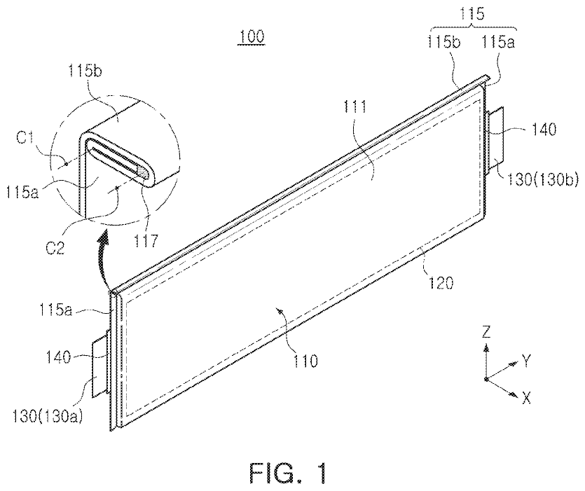

FIG. 1 illustrates an example of a battery cell based on an embodiment of disclosed technology.

Referring to FIG. 1, the battery cell 100 may include a pouch 110, an electrode assembly 120, and an electrode lead 130. The battery cell 100 may be configured as a secondary battery. For example, the battery cell 100 may be implemented as a lithium ion battery, but the disclosed technology is not limited thereto. For example, the battery cell 100 may be implemented as a nickel-cadmium electric battery, a nickel-metal hydride battery, or a nickel-hydrogen battery which may be charged and discharged.

The pouch 110 may form at least a portion of an exterior of the battery cell 100. The pouch 110 may include an electrode receiving portion 111 for accommodating the electrode assembly 120 and a sealing portion 115 for sealing at least a portion of the circumference of the electrode receiving portion 111. The electrode receiving portion 111 may provide a space to accommodate the electrode assembly 120 and an electrolyte solution.

The sealing portion 115 may be formed by bonding at least a portion of the perimeter of the pouch 110. The sealing portion 115 may include a flange extending outward from the electrode receiving portion 111, which is formed in the shape of a container, and may be disposed along at least a portion of an outer portion of the electrode receiving portion 111. In an embodiment, the sealing portion 115 may include a first sealing portion 115a, in which the electrode lead 130 is disposed, and a second sealing portion 115b, in which the electrode lead 130 is not disposed. A portion of the electrode lead 130 may extend or be exposed to the outside of the pouch 110. To increase seal the first sealing portion 115a and to ensure an electrical insulation, the electrode lead 130, a portion of which extends or is exposed to the outside of the pouch 110, may be covered by the insulating film 140. The insulating film 140 may be formed of a material or a film having a thickness smaller than that of the electrode lead 130, and may be attached to both surfaces of the electrode lead 130.

In an embodiment, the electrode leads 130 may be disposed in opposite directions on both sides of the battery cell 100 in the length direction (Y-axis direction). For example, the electrode lead 130 may include a positive lead 130a having a first polarity (e.g., a cathode) facing one side (e.g., the first direction (+Y-direction)) of the battery cell 100 in the length direction and a negative lead 130b having a second polarity (e.g., an anode) facing the other side (e.g., the second direction (−Y-direction)) in the length direction. As illustrated in FIG. 1, in an embodiment, the sealing portion 115 may include two first sealing portions 115a in which the electrode lead 130 is disposed and a second sealing portion 115b in which the electrode lead 130 is not disposed.

The direction in which electrode lead 130 is disposed may be selectively determined. In an embodiment (e.g., the example shown in FIG. 1), the electrode lead 130 may include the positive lead 130a and the negative lead 130b disposed in the opposite direction of the positive lead 130a with respect to the electrode assembly 120. In FIG. 1, the electrode leads 130 may be disposed to face in opposite directions on both sides of the battery cell 100 in the length direction (e.g., Y-axis direction), but the structure of the electrode leads 130 is not limited thereto. For example, the two electrode leads 130 may be arranged substantially in parallel in the length direction (e.g., Y-axis direction) of the battery cell 100.

The pouch 110 is not limited to the structure in which the sealing portion 115 is formed on three sides by folding a sheet of exterior material as illustrated in FIG. 1.

In an embodiment, at least a portion of the sealing portion 115 may be formed in a folded shape, folded at least once. By folding at least a portion of the sealing portion 115, bonding reliability of the sealing portion 115 may be improved and the area of the sealing portion 115 may be reduced. Among the sealing portions 115 implemented based on an embodiment, the second sealing portion 115b in which the electrode lead 130 is not disposed may be folded twice and fixed by the adhesive member 117. For example, the second sealing portion 115b may be folded by 180° along a first bent line C1 and may be folded again along a second bent line C2. In this case, the adhesive member 117 may be disposed in the second sealing portion 115b. For example, the second sealing portion 115b may be filled with the adhesive member 117.

The bending angle and the number of folding of the second sealing portion 115b may vary. For example, in an embodiment, the second sealing portion 115b may be folded by 90° with respect to the first sealing portion 115a.

The electrode assembly 120 may include a cathode plate, an anode lead, and a separator. The separator may prevent contact between the cathode plate and the anode lead. The electrode assembly 120 may be manufactured in various ways (e.g., stacked, jelly roll, or Z-folded methods).

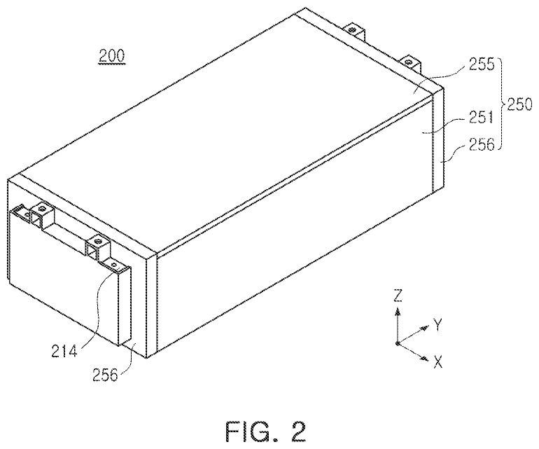

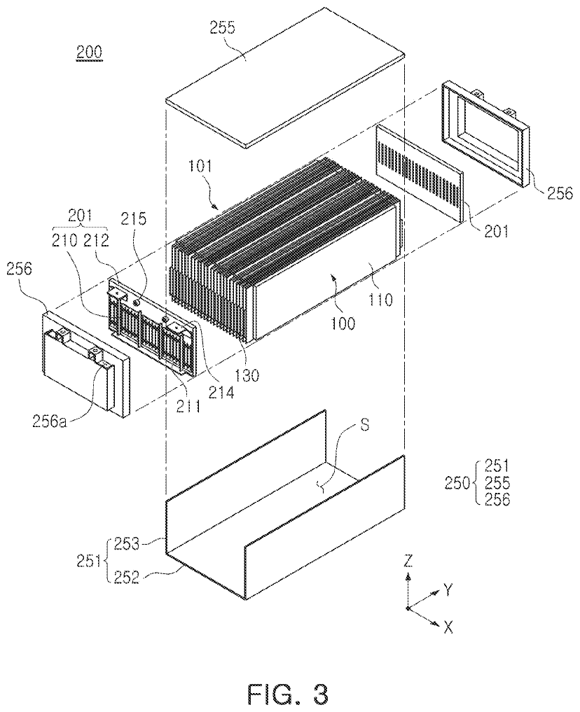

FIG. 2 illustrates an example of a battery module based on an embodiment of disclosed technology. FIG. 3 illustrates an example of a battery module based on an embodiment of disclosed technology.

Referring to FIG. 2 and/or FIG. 3, a battery module 200 may include a cell assembly 101, a busbar assembly 201, and a case 250. The cell assembly 101 may include a plurality of battery cells 100. The features of the battery cell 100 discussed above with reference to FIG. 1 may be applied to the battery cell 100 in FIG. 3.

Examples of the battery module 200 based on an embodiment may include a battery device or a battery pack.

The cell assembly 101 may have a substantially hexahedral shape. In an embodiment, the cell assembly 101 may be referred to as a cell stack.

The busbar assembly 201 may include an electrically conductive busbar 210 and an electrically insulating support plate 212 electrically connected to the electrode lead 130 of the battery cell 100. The support plate 212 may be referred to as a busbar frame. At least a portion of the support plate 212 may be disposed between the cell assembly 101 and the busbar 210 and may support the busbar 210. The support plate 212 may include at least one through hole 215 for receiving coupling components (e.g., screws, rivets, and/or boss structures). By the coupling component, the support plate 212 may be coupled to a portion (e.g., end plate 256) of the case 250. The shape of the busbar 210 illustrated in FIG. 3 may vary. For example, the shape and number of slits 211 formed on the busbar 210 may be selectively changed.

The busbar assembly 201 may include at least one connection terminal 214 for electrical connection with an external structure or device. The electrode lead 130 of the battery cell 100 may be electrically connected to an external structure or device disposed outside the battery module 200 through the busbar 210 and the connection terminal 214. For example, the connection terminal 214 may be connected to the busbar 210 through a wire or a conductive structure (not illustrated), and a current from the battery cell 100 may be transmitted to the outside of the battery module 200 through the busbar 210 and the connection terminal 214. The connection terminal 214 may be exposed to the outside of the case 250 through the hole 256a of the end plate 256.

The case 250 may form an accommodation space S for accommodating the cell assembly 101 and/or the busbar assembly 201. For example, the case 250 may include a cover 255 covering the cell assembly 101 and a receiving portion 251 surrounding a lower surface and side surfaces of the cell assembly 101. The receiving portion 251 may include a main plate 252 covering the lower surface of the cell assembly 101 and a plurality of sidewall members 253 covering at least a portion of the side surfaces of the cell assembly 101. At least a portion of the accommodation space S may be surrounded by the main plate 252, the sidewall member 253 and the end plate 256. In an embodiment, the main plate 252 and the sidewall member 253 may be formed integrally.

The case 250 may include an end plate 256 covering a portion of the side surface of the cell assembly 101. In an embodiment, the end plate 256 may be connected to both ends of the main plate 252 and the sidewall member 253 in the length direction (e.g., Y-axis direction). The end plate 256 may cover a portion of the side surface of the cell assembly 101 and the busbar assembly 201. The end plate 256 may include a hole 256a for accommodating the connection terminal 214.

In an embodiment, case 250 may include a material having high thermal conductivity, such as metal. For example, the case 250 may include aluminum. However, the material of the case 250 is not limited thereto. In another embodiment, the case 250 may include polymer. The case 250 may be referred to as a housing, a module housing, or a module case.

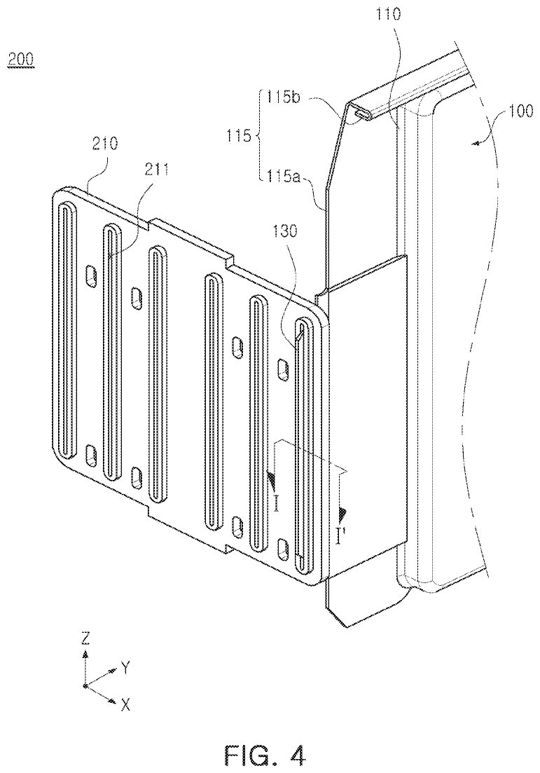

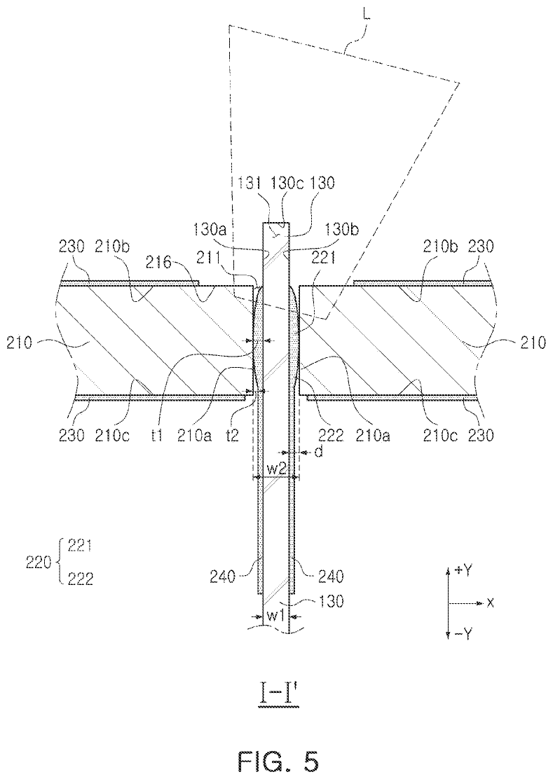

FIG. 4 illustrates an electrode lead and a busbar of an example of a battery cell based on an embodiment of disclosed technology. FIG. 5 is a cross-sectional diagram taken along line I-I′ in FIG. 4 of disclosed technology.

Referring to FIGS. 4 and 5, a battery module 200 may include a busbar 210 including a slit 211 and a battery cell 100 including an electrode lead 130 inserted into the slit 211. The features of the battery cell 100 and the busbar 210 discussed above with reference to FIGS. 1, 2, and/or 3 may be applied to the battery cell 100 and the busbar 210 in FIGS. 4 and 5.

The battery module 200 may include a bonding member 220 that is electrically conducting and connects the busbar 210 to the electrode lead 130. At least a portion of the bonding member 220 may be disposed between the busbar 210 and the electrode lead 130. For example, the bonding member 220 may be disposed in the slit 211 of the busbar 210. The busbar 210 may include an internal surface 210a forming the slit 211. The bonding member 220 may be disposed between the internal surface 210a of the busbar 210 and the side surfaces 130a and 130b of the electrode lead 130. The busbar 210 may be electrically connected to the electrode lead 130 using the bonding member 220. For example, the bonding member 220 may include an electrically conductive material (e.g., a solder). The electrode lead 130 may be connected to the busbar 210 using the bonding member 220. The electrode lead 130 may not be in direct contact with or connected to the busbar 210. For example, the electrode lead 130 may be spaced apart from the internal surface 210a of the busbar 210.

In an embodiment, the second width w2 of the slit 211 may be 3 times the first width w1 of the electrode lead 130. For example, the first width w1 of electrode lead 130 may be in 0.5 mm, and the second width w2 may be in 1.5 mm. Since the first width w1 and the second width w2 are formed to have a predetermined length, the electrode lead 130 and the busbar 210 may be electrically connected using the electrically conducting bonding member 220.

In an embodiment, the distance d between the side surfaces 130a and 130b of the electrode lead 130 and the internal surface 210a of the busbar 210 may be 1.0 mm or less. The distance d between the side surfaces 130a and 130b of the electrode lead 130 and the internal surface 210a of the busbar 210 may be 1.0 mm or less. In this way, the connection or bonding strength between the electrode lead 130 and the busbar 210 may be improved.

The busbar 210 may include a surface 216 that is not covered by the first coating layer 230 and is visually exposed to the outside of the busbar 210. For example, when laser L is applied to the first coating layer 230, a portion of the first coating layer 230 adjacent to the slit 211 may melt and flow into a space between the busbar 210 and the electrode lead 130 due to capillary action. For example, a portion of the molten first coating layer 230 may spread into the space between the busbar 210 and the electrode lead 130. As a portion of the first coating layer 230 is moved to the electrode lead 130, a portion of the upper surface 210b of the busbar 210 and at least a portion of the rear surface 210c may be exposed. The laser L may be a light beam of a predetermined wavelength provided from a device external to the battery module 200 to the busbar 210 and the electrode lead 130.

A melting point of the bonding member 220 may be lower than a melting point of the busbar 210 and a melting point of the electrode lead 130. The electrode lead 130 may include copper or aluminum. The melting point of the electrode lead 130 including copper may be about 1000 degrees. The melting point of the electrode lead 130 including aluminum may be about 660 degrees. The busbar 210 may include copper. The melting point of the busbar 210 may be approximately 1000 degrees. The melting point of the bonding member 220 may be 250 degrees or lower. For example, the melting point of the bonding member 220 may be about 200 degrees. The bonding member 220 may be referred to as solder. For example, the bonding member 220 may include at least one of tin, lead, copper, or silver. Since the melting point of the bonding member 220 is lower than the melting point of the electrode lead 130 and the melting point of the busbar 210, a short circuit may be prevented in a heat transfer situation. For example, as the bonding member 220 melts at about 200 degrees, the busbar 210 and the electrode lead 130 may be spaced apart from each other. As the busbar 210 and the electrode lead 130 are spaced apart from each other at a relatively low temperature (e.g., 200 degrees), thermal propagation, flame propagation, and/or a short circuit may be reduced or prevented. In addition, by coupling the busbar 210 to the electrode lead 130 at a relatively low temperature, welding quality may be improved, and thermal strain may be reduced.

The bonding member 220 may be formed using capillary action. For example, by the laser L provided from the outside to the battery module 200, at least a portion of the first coating layer 230 and/or at least a portion of the second coating layer 240 may flow into the space between the electrode lead 130 and the busbar 210.

Due to capillary action and surface tension of the materials (e.g., tin, lead, copper and/or silver) of the molten coating layers 230 and 240, at least a portion of the bonding member 220 may have a curved shape. For example, the bonding member 220 may include a central portion 221 and an edge portion 222 having different thicknesses. The first thickness t1 of the central portion 221 may be greater than the second thickness t2 of the edge portion 222. In an embodiment, the central portion 221 of the bonding member 220 may be in contact with the electrode lead 130 and the busbar 210. The edge portion 222 may be in contact with the electrode lead 130 or the busbar 210. For example, the edge portion 222 may be in contact with the electrode lead 130 and not in contact with the busbar 210.

The battery module 200 may include a first coating layer 230 covering at least a portion of the busbar 210. The first coating layer 230 may cover at least a portion of the surface of the busbar 210. For example, the first coating layer 230 may cover at least a portion of an internal surface 210a, an upper surface 210b and a rear surface 210c of the busbar 210.

At least a portion of the first coating layer 230 may be melted and may form the bonding member 220. In an embodiment, a portion of the first coating layer 230 coated on the internal surface 210a of the busbar 210 or on the upper surface 210b and rear surface 210c adjacent to the internal surface 210a may be melted by a laser to form the bonding member 220. In an embodiment, the first coating layer 230 may be referred to as a bonding member layer or a first bonding member layer.

The battery module 200 may include a second coating layer 240 covering at least a portion of the electrode lead 130. The second coating layer 240 may cover at least a portion of the surface of the electrode lead 130. For example, the second coating layer 240 may cover a portion of electrode lead 130 adjacent to the end 131 of electrode lead 130. In an embodiment, the second coating layer 240 may cover at least a portion of the side surfaces 130a and 130b of the electrode lead 130 and the front surface 130c.

At least a portion of the second coating layer 240 may melt to form the bonding member 220. In an embodiment, a portion of the second coating layer 240 coated on the electrode lead 130 may be melted by a laser to form the bonding member 220. In an embodiment, the second coating layer 240 may be referred to as a bonding member layer or a second bonding member layer.

The bonding member 220 may be formed using laser welding. For example, the bonding member 220 may be formed by melting at least one of the first coating layer 230 or the second coating layer 240. In an embodiment, the bonding member 220 may be a portion of the first coating layer 230 and/or a portion of the second coating layer 240 melted using laser welding. The melting point of the first coating layer 230 may be lower than the melting point of the busbar 210 and the melting point of the electrode lead 130. The first coating layer 230 may include tin, lead, copper and/or silver. The melting point of the second coating layer 240 may be lower than the melting point of the busbar 210 and the melting point of the electrode lead 130. The second coating layer 240 may include tin, lead, copper and/or silver. In another embodiment, the bonding member 220, the first coating layer 230, and/or the second coating layer 240 may include tin, lead, copper, zinc, antimony, indium, bismuth, silicon, silver, and/or gold. For example, bonding member 220 may be a flux including a lead alloy.

By forming the bonding member 220 by using the coating layers 230 and 240, the busbar 210 and the electrode lead 130 may be coupled to each other regardless of the length at which the electrode lead 130 protrudes with respect to the busbar 210. For example, when coupling the busbar 210 to the electrode lead 130 by filling a conductive material, as the length of the electrode lead 130 protruding from the busbar 210 increases, the coupling force between the busbar 210 and the electrode lead 130 may decrease.

In some embodiments, the bonding member 220 is formed by the coating layers 230 and 240 without requiring an additional structure of the busbar 210. For example, when coupling the busbar 210 to the electrode lead 130 by forming or filling the conductive material, the busbar 210 (e.g., a groove adjacent to the slit 211) may have a shape suitable for disposing the filler. It may not be necessary for the battery module 200 including coating layers 230 and 240 to include a groove on the busbar 210 for the filler.

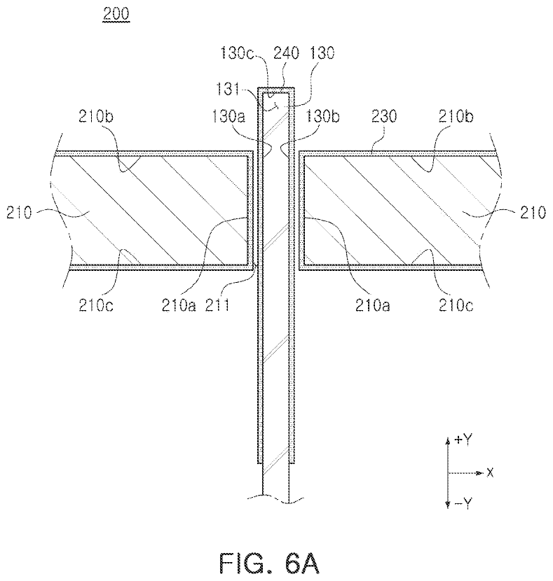

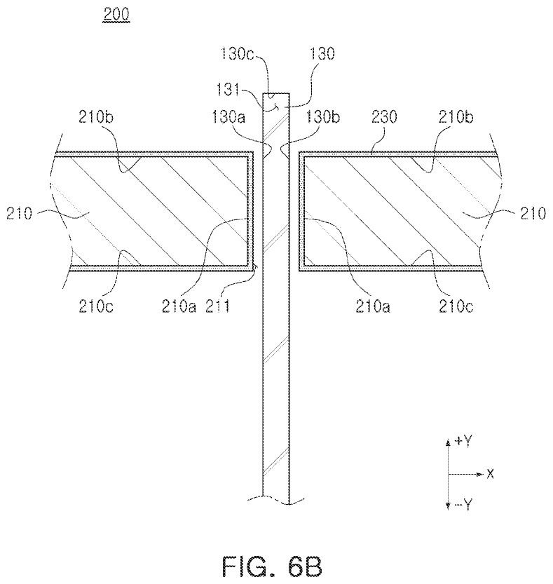

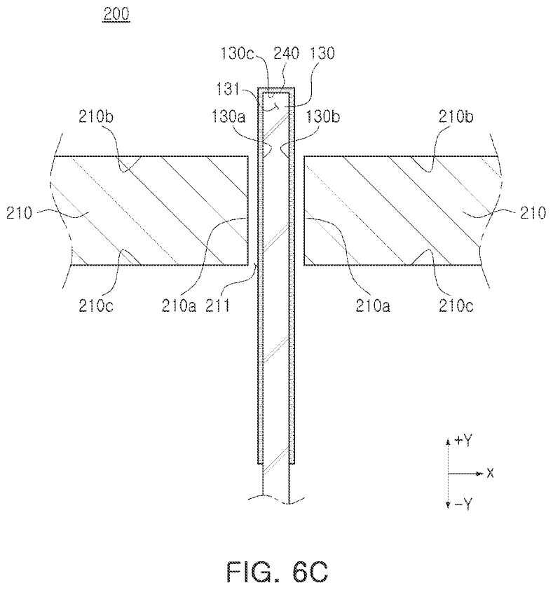

FIGS. 6A, 6B, and 6C are cross-sectional diagram illustrating an example of a battery module according to various embodiments of disclosed technology.

Referring to FIGS. 6A, 6B, and/or 6C, the battery module 200 may include an electrode lead 130, a busbar 210, a first coating layer 230, and/or a second coating layer 240. The features of the battery module 200, the electrode lead 130, the busbar 210, the first coating layer 230, and/or the second coating layer 240 discussed above with reference to FIGS. 4 and/or 5 may be applied to FIGS. 6A, 6B, and/or 6C.

The battery module 200 may include at least one of a first coating layer 230 or a second coating layer 240. For example, depending on the design of the battery module 200, the first coating layer 230 or the second coating layer 240 may be excluded. Through welding using a laser (e.g., laser L in FIG. 5), at least one of the first coating layer 230 or the second coating layer 240 may be melted to form a bonding member (e.g., bonding member 220 in FIG. 5).

Referring to FIG. 6A, the bonding member 220 may be formed by a first coating layer 230 and a second coating layer 240. For example, at least a portion of the busbar 210 may be surrounded by the first coating layer 230, and at least a portion of the electrode lead 130 may be surrounded by the second coating layer 240. As the battery module 200 may include the first coating layer 230 and the second coating layer 240, the bonding strength between the electrode lead 130 and the busbar 210 may be increased.

Referring to FIG. 6B, the bonding member 220 may be formed by the first coating layer 230. For example, the busbar 210 may be surrounded by a first coating layer 230, and the electrode lead 130 may not be surrounded by a coating layer. As the battery module 200 includes the first coating layer 230 and does not include the second coating layer 240, the weight of the battery module 200 may be reduced.

Referring to FIG. 6C, the bonding member 220 may be formed by the second coating layer 240. For example, electrode lead 130 may be surrounded by a second coating layer 240, and the busbar 210 may not be surrounded by a coating layer. As the battery module 200 includes the second coating layer 240 and does not include the first coating layer 230, the weight of the battery module 200 may be reduced.

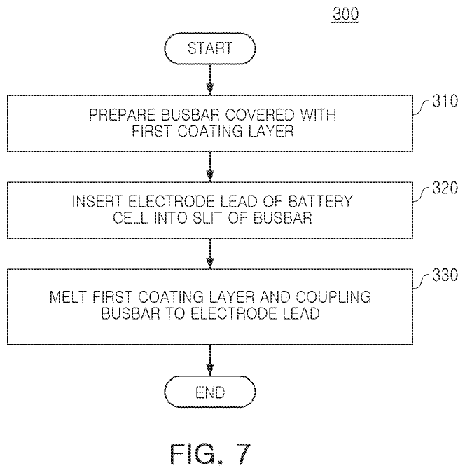

FIG. 7 is a flowchart illustrating a method of manufacturing a battery module based on an embodiment of disclosed technology.

Referring to FIG. 7, a method 300 of manufacturing a battery module may include, at 310, preparing a busbar covered with a first coating layer, at 320, inserting an electrode lead of a battery cell into a slit of the busbar, and at 330, melting the first coating layer and coupling the busbar to the electrode lead.

The method 300 of manufacturing a battery module in FIG. 7 may correspond to the method of manufacturing the battery module 200 described in FIGS. 3 to 6C. For example, the features of the electrode lead 130, the busbar 210, the bonding member 220, the first coating layer 230, and/or the second coating layer 240 discussed above with reference to in FIGS. 5, 6A, 6B, and/or 6C may be applied to the example in FIG. 7.

In an embodiment, in the process 310 of preparing the busbar 210 covered with the first coating layer 230, the busbar 210 covered with the first coating layer 230 may be manufactured by being dipped into the molten raw material of the first coating layer 230. For example, using a jig, the busbar 210 may be submerged in an alloy including molten tin, lead, copper, and/or silver and may be pulled out. The busbar 210 covered with the first coating layer 230 may correspond to the busbar 210 coated with the first coating layer 230. In an embodiment, the process of coating the first coating layer 230 on the busbar 210 may be applied to the process of coating the second coating layer 240 on the electrode lead 130.

In an embodiment, the process 330 of melting the first coating layer 230 and coupling the busbar 210 to the electrode lead 130 may be performed using laser welding. For example, by a laser (e.g., laser L in FIG. 5) provided to the busbar 210 and the electrode lead 130, at least a portion of the first coating layer 230 may be melted and may form the bonding member 220. As the molten bonding member 220 hardens, the electrode lead 130 and the busbar 210 may be coupled or connected to each other. The method of melting the first coating layer 230 is not limited to laser. For example, any process of melting the first coating layer 230, such as ultrasonic welding, may be applied to the process 330 of the coupling busbar 210 and the electrode lead 130.

In an embodiment (e.g., FIG. 6A), the process 330 of coupling the busbar 210 to the electrode lead 130 by melting the second coating layer 240 may be performed together with the process of coupling the busbar 210 to the electrode lead 130 by melting the second coating layer (e.g., second coating layer 240 in FIG. 5). For example, the busbar 210 in FIG. 6A may be covered by the first coating layer 230, and the electrode lead 130 may be covered by the second coating layer 240. By melting the first coating layer 230 and the second coating layer 240, the bonding member 220 may be formed. The bonding member 220 may connect the electrode lead 130 to the busbar 210.

In an embodiment (e.g., FIG. 6C), the process 330 of coupling the busbar 210 to the electrode lead 130 by melting the second coating layer 240 may be replaced with the process of coupling the busbar 210 to electrode lead 130 by melting the second coating layer (e.g., the second coating layer 240 in FIG. 5). For example, as the electrode lead 130 in FIG. 6C may be covered by the second coating layer 240, and the second coating layer 240 is melted, the bonding member 220 may be formed. The bonding member 220 may connect the electrode lead 130 to the busbar 210.

As discussed above, the disclosed technology can be implemented in some embodiments to improve the welding quality of battery cell electrode leads and busbars.

In addition, the disclosed technology can be implemented in some embodiments to reduce the thermal propagation, flame propagation, and short circuit between plurality of battery cells.

In addition, the disclosed technology can be implemented in some embodiments to reduce the difficulty of the battery module production process and the defect rate of produced battery modules.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs).

Only specific examples of implementations of certain embodiments are described. Variations, improvements and enhancements of the disclosed embodiments and other embodiments may be made with respect to the disclosure of this patent document.

What is claimed is:

1. A battery module, comprising:
a battery cell operable to produce electricity and including an electrode lead that conducts the produced electricity;
a busbar formed from an electrically conducting busbar material and structured to include a slit that accommodates the electrode lead;
a first coating layer disposed on the busbar to cover at least a portion of the busbar; and
a bonding member formed of an electrically conducting material and disposed between the electrode lead and the busbar to electrically connect the electrode lead to the busbar.

2. The battery module of claim 1,
wherein the bonding member includes a central portion and an edge portion extending from the central portion, wherein the central portion is in contact with the electrode lead and the busbar, and
wherein a thickness of the central portion is greater than a thickness of the edge portion.

3. The battery module of claim 1,
wherein the busbar includes an internal surface forming the slit, and
wherein a side surface of the electrode lead is spaced apart from the internal surface of the busbar.

4. The battery module of claim 1, wherein the busbar includes a surface that is not covered by the first coating layer and is visually exposed to an outside of the busbar.

5. The battery module of claim 1, further comprising:
a second coating layer disposed on the electrode lead to cover at least a portion of the electrode lead.

6. The battery module of claim 1, wherein a melting point of the bonding member and a melting point of the first coating layer are lower than a melting point of the electrode lead and a melting point of the busbar.

7. The battery module of claim 1, wherein a width of the slit of the busbar is within three times a width of the electrode lead.

8. The battery module of claim 1, wherein the first coating layer and the bonding member include at least one of tin (Sn), lead (Pb), copper (Cu), or silver (Ag).

9. A battery module, comprising:
a battery cell operable to produce electricity and including an electrode lead that conducts the produced electricity;
a busbar formed from an electrically conducting busbar material and including a slit structured to accommodate the electrode lead; and
a bonding member formed of an electrically conducting material and disposed in a space inside the slit between the electrode lead and the busbar to electrically connect the electrode lead to the busbar.

10. The battery module of claim 9, further comprising:
a first coating layer disposed on the busbar to cover at least a portion of the busbar.

11. The battery module of claim 9, further comprising:
a second coating layer disposed on the electrode lead to cover at least a portion of the electrode lead.

12. The battery module of claim 9,
wherein the bonding member includes a central portion and an edge portion extending from the central portion, wherein the central portion is in contact with the electrode lead and the busbar, and
wherein a thickness of the central portion is greater than a thickness of the edge portion.

13. The battery module of claim 9,
wherein the busbar includes an internal surface forming the slit, and
wherein a side surface of the electrode lead is spaced apart from the internal surface of the busbar.

14. A method of manufacturing a battery module including at least one battery cell, comprising:
preparing a busbar including a first coating layer disposed on the busbar;
inserting an electrode lead of the at least one battery cell into a slit of the busbar; and
coupling the busbar to the electrode lead by melting the first coating layer.

15. The method of claim 14, wherein coupling the busbar to the electrode lead includes melting a second coating layer covering the electrode lead together with the first coating layer.
